(19) United States
(12) Patent Application Publication
(10) Pub. No.: US 2014/0304715 A1
(43) Pub. Date: Oct. 9, 2014

(54) APPARATUS AND METHOD FOR PROCESSING EVENT

(71) Applicant: Pantech Co., Ltd., Seoul (KR)

(72) Inventors: Min-Seok PARK, Seoul (KR); Yang-Hoon SHIN, Seoul (KR)

(73) Assignee: Pantech Co., Ltd., Seoul (KR)

(21) Appl. No.: 14/247,038

(22) Filed: Apr. 7, 2014

(30) Foreign Application Priority Data
Apr. 8, 2013 (KR) 10-2013-0038279

(51) Int. Cl. G06F 9/54

(52) U.S. Cl. CPC G06F 9/542
USPC 719/318

(57) ABSTRACT

A mobile terminal and method provide an event user interface (UI) based on the execution status of the mobile terminal. The method for processing an event includes executing a first application of a mobile terminal, recognizing an event to be indicated via the mobile terminal, the event being associated with a second application of the mobile terminal, determining whether to configure an event user interface (UI) or to provide a default UI of the second application based on at least one of UI state information of the executed first application and setting information for configuring the event UI, and providing the event UI for indicating the event.

### CROSS-REFERENCE TO RELATED APPLICATIONS

This application claims priority from and the benefit under 35 U.S.C. §119(a) of Korean Patent Application No. 10-2013-0038279, filed on Apr. 8, 2013, which is hereby incorporated by reference for all purposes as if fully set forth herein.

### BACKGROUND

1. Field

The following description relates to an apparatus and a method for processing an event, and more specifically, an apparatus and a method for processing an event that occurs while applications are being executed in the apparatus.

2. Discussion of the Background

Technological developments in mobile devices and widespread commercialization of mobile devices have led to the fast emergence of various smart devices. Especially, smartphones are one of the most successful types of the smart devices, and are quickly encroaching on the feature phone market. As the functions of pre-existing feature phones were mainly focused on the voice communication functions as a phone, smartphone's core functions are more diverse in using content through various applications. A user may perform web-surfing through smart devices, and use various pieces of content and applications, such as video content and game content, etc.

In certain mobile devices, if the user receives a Short Message Service (SMS) message, a call connection message or any other notification message, and the like in the process of using various pieces of content and applications, contents or applications displayed on a display screen may be automatically switched to a display of a call connection or SMS message. Further, if an event disturbs executed content or application by displaying a pop-up window on a display screen, the user may feel inconvenience in using the content or the application. In some cases, an application that is currently running may be stopped or terminated due to receiving a message or answering a call, and the like, so the user may feel convenience.

To address the problems, several methods have been provided. One of the methods is to set a specific time or a subject as an exception and to prohibit an event notification of displaying a user interface (UI) on a screen for events related to the time or object set as the exception, such as receiving a message or connecting to a call, etc. Through those methods, the user may not be disturbed when receiving a message or a call at night while sleeping. However, in order to use these methods, exceptional events should be individually set in advance, and when events, which are not set as the exception, occur, executed contents or applications may be disturbed. Further, the user may not recognize whether the event occurred or when the event occurred.

### SUMMARY

Exemplary embodiments of the present invention provide an apparatus and a method for processing an event.

Additional features of the invention will be set forth in the description which follows, and in part will be apparent from the description, or may be learned by practice of the invention.

Exemplary embodiments of the present invention provide a method for processing an event, including: executing a first application of a mobile terminal; recognizing an event to be indicated via the mobile terminal, the event being associated with a second application of the mobile terminal; determining whether to configure an event user interface (UI) or to provide a default UI of the second application based on at least one of UI state information of the executed first application and setting information for configuring the event UI; and providing the event UI for indicating the event.

Exemplary embodiments of the present invention provide a method for processing an event, including: executing a first application of a mobile terminal; recognizing an event to be indicating via the mobile terminal, the event being associated with a second application of the mobile terminal; determining to configure an event user interface (UI) if the first application is executed in a full-screen mode, the event UI providing an adjusted user interface different from a default UI of the second application; and providing the event UI for indicating the event.

Exemplary embodiments of the present invention provide a mobile terminal to process an event, including: a non-transitory storage device including executable instructions which, when executed by one or more processors, causes the one or more processors to perform: executing a first application of the mobile terminal; recognizing an event to be indicated via the mobile terminal, the event being associated with a second application of the mobile terminal; determining whether to configure an event user interface (UI) or to provide a default UI of the second application based on at least one of UI state information of the executed first application and setting information for configuring the event UI; and providing the event UI for indicating the event.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an apparatus to process an event according to an exemplary embodiment of the present invention.

FIG. 2 is a flowchart illustrating a method for processing an event by an apparatus according to an exemplary embodiment of the present invention.

FIG. 3 is a flowchart illustrating a method for processing an event according to an exemplary embodiment of the present invention.

FIG. 4 is a diagram illustrating an event user interface (UI) of receiving a call displayed on an apparatus according to an exemplary embodiment of the present invention.

FIG. 5A, FIG. 5B, and FIG. 5C are diagrams illustrating an event UI of receiving a call displayed on an apparatus according to an exemplary embodiment of the present invention.

FIG. 6A and FIG. 6B are diagrams illustrating an event UI related to a task event displayed on an apparatus according to an exemplary embodiment of the present invention.

FIG. 7 is a diagram illustrating an event UI displayed on an apparatus according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

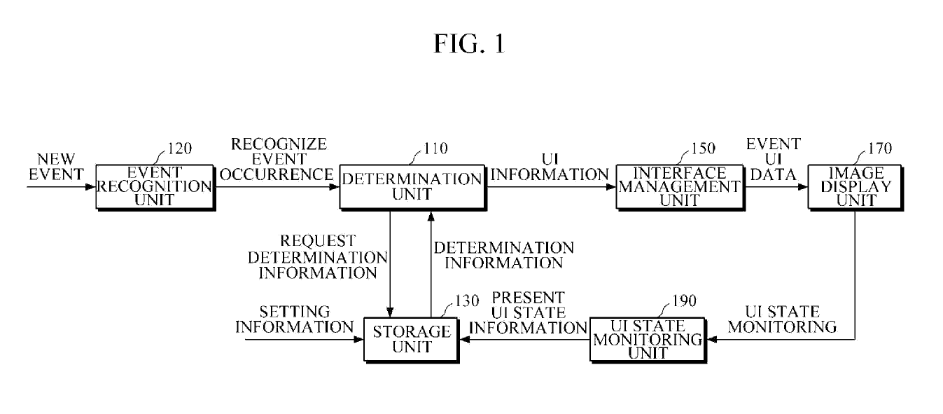

FIG. 1 is a diagram illustrating an apparatus to process an event according to an exemplary embodiment of the present invention.

Referring to FIG. 1, the apparatus includes a determination unit 110, an event recognition unit 120, a storage unit 130, an interface management unit 150, and an image display unit 170.

FIG. 1 illustrates an example of a suitable computing device in which one or more of exemplary embodiments may be implemented, however, various computing device or system configurations may be used. The apparatus illustrated in FIG. 1 is not intended to suggest any limitation but to show an exemplary configuration for implementing the illustrated embodiments. The apparatus may include one or more processors, memories, touch screen displays, wireless communication modules, image processing modules, image sensing modules, I/O modules, and the like. The one or more processors execute computer-executable instructions and may include an application processor. For a multi-processing environment, multiple processing units may execute program instructions of multiple applications such that a multi-tasking of processing an event while executing one or more applications is possible.

An event recognition unit 120 recognizes the occurrence of an event, and recognizes a new event, which occurs in the process of executing applications. When a first application is running on the forefront screen layer, if an event related to a second application is recognized, the event recognition unit 120 recognizes and transmits that event to a determination unit 110. Here, the first application is an application (e.g., an application running in the foreground) that is running on the foremost layer among screen layers, and the second application may be another application besides the first application, e.g., a background application running in a background. For example, if a new Short Message Service (SMS) message is received while a video player is running on the forefront screen layer, the video player may be the first application running in the foreground, and the application, which receives and processes the SMS reception event, may be the second application. Also, the event recognition unit 120 may further include a module which determines, whether a recognized new event is associated with the first application or the second application. Also, the determination unit 110 may determine whether the recognized new event is associated with the first application or the second application.

If the event recognition unit 120 recognizes new event occurrence, a recognition unit 110 sends a request for determination information to a storage unit 130. The determination information may include setting information and UI state information. The setting information includes information about event process instructions, e.g., whether to indicate the event, event notification formats, and the like, depending on an event type, the currently running application type, and the state of the running application. The setting information may be set by a user, or set in each application according to a default setting. UI state information includes information about a type, attribute, and/or state of the foreground application or a state of the foreground application window, which is currently running in the foreground. The application state may be divided into a full-screen mode in which is full screen is used by the foreground application or a non-full-screen mode in which the foreground application is displayed on a portion of a display screen without expanded into the full screen. How to classify a full-screen state and a non-full-screen state may vary. For example, even though the foreground application is displayed on a portion of the display screen, the state may be determined as a full-screen mode if the remaining area of the display is not large enough to display an event UI according to the default setting. Further, through attribute information on the application, it may be determined whether the application currently running is in a full-screen mode. For example, a mobile terminal using Android™ Operating System (OS) classifies the state of the display screen through Manifest information. Also, the state of the display screen may be classified by whether a status bar or a notification bar, which shows an occurring event, exists on an upper screen of a smartphone or a tablet PC. The method to classify whether the application is in a full-screen mode through the status bar or the notification bar may be optional and the method of determining the full-screen mode is not limited thereto.

The setting information includes settings about whether the event is received and whether an event UI is used in the apparatus and method for processing an event. The setting information may be different according to the current screen state or an application type. In an example, according to the determination whether the application runs in full-screen mode or not, the apparatus may determine whether the application will use the event UI. If the application runs in the full-screen mode, the apparatus and method informs a user that an event occurring through the event UI, which does not significantly disturbs the full screen mode. If the application does not run in the full-screen mode, the apparatus and method informs the user of event occurrence according to the default setting of each application. In the full-screen mode, it may be unavailable for the user to check the status bar or the notification bar, so the user may not notice the event. Also, the running application screen may be automatically switched to the occurring event, or a pop-up message that informs of the event occurrence may be shown on the screen. To address the problems described above, the event UI may be automatically used according to the determination that the application is in the full-screen mode. Further, even though it is determined not in the full-screen mode, if the pop-up message is generated on the screen, the pop-up message may hide some parts of the executed content or application displayed on the screen, so the event UI may be utilized instead of the pop-up message.

Further, the setting information may enable to individually set a usage condition of the event UI for each of applications included in a mobile terminal. For example, the setting information may classify two or more applications, which are included in a mobile terminal, into categories of a game, multimedia, and communication, etc., and set the usage condition of the event UI depending on a classified item, or depending on each individual application. Also, the usage condition of the event UI may be set depending on a time, a place, and/or an event type.

As described above, the event UI usage condition of the setting information may be set depending on the event, the currently running application type and an attribute of the currently running application, and/or depending on a standard that the user sets.

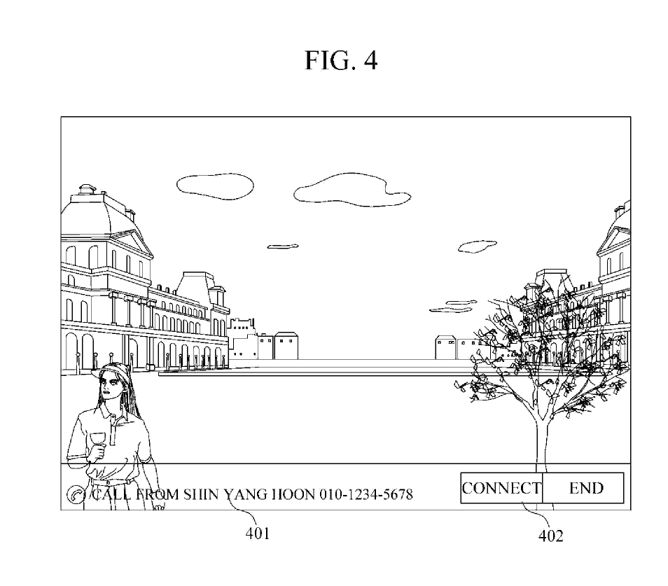

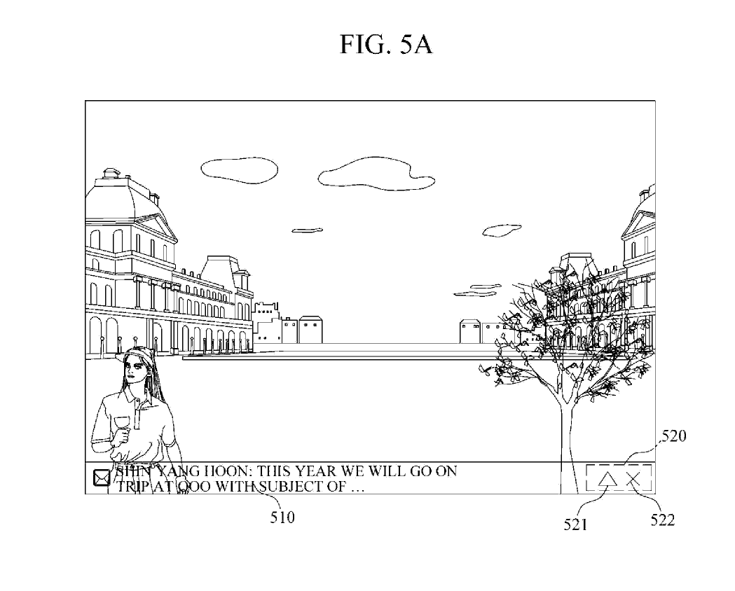

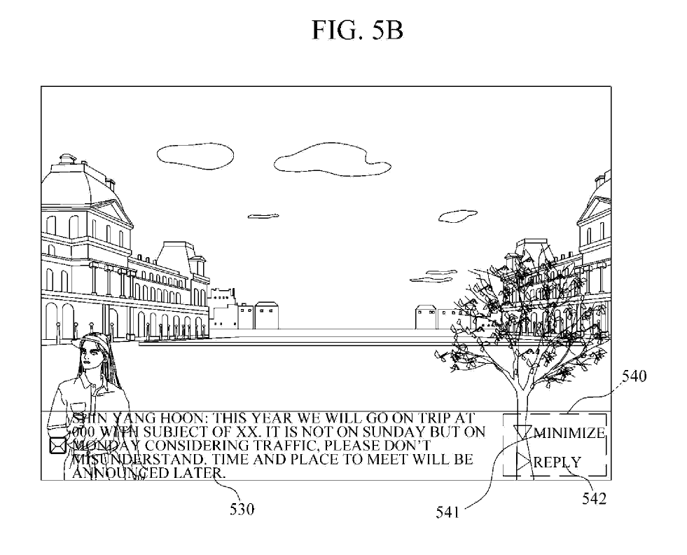

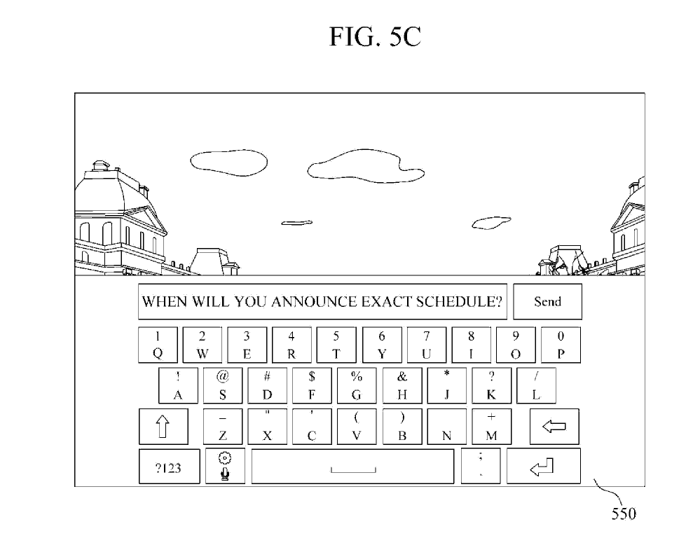

The event UI is a user interface that gives the occurrence and the simple information about the occurring event when a new event occurs. The event UI may not need to terminate the application or to pause the application that is currently running in the foreground, or switch the screen. The event UI may be displayed on the application running in the foreground. More specifically, the event UI keeps the executed state of the application currently running in the foreground, and provides information of an occurring event without interrupting the execution of the foreground application on the screen. The event UI may run on the application currently running in the foreground, and, for example, the event UI may be shown in the form of adding an additional layer on the screen layer of the application running in the foreground. Further, the event UI may be designed to be displayed (shown), preferably on the top, bottom, left or right side(s) not to significantly interrupt the screen of the application running in the foreground. Also, the event UI may be displayed transparently or translucently, and the user may adjust the transparency. The event UI may be displayed in the form of ‘Always on Top’ (AOT). A display location of the event UI may also be changed and/or adjusted by the user, and after being displayed, the user may change the location as well. Accordingly, while keeping the user to use the application that is currently running, the user may receive an event occurring at the same time and then respond to the event through the even UI. The event UI will be described in more detail with reference to FIG. 4 and FIG. 5.

Also, the determination unit 110 determines whether to utilize the event UI based on determination information and a new event, which are received from the storage unit 130 or other elements of the apparatus. More specifically, the determination unit 110 compares the received event and the UI state information included the determination information with the preset setting information, and determines whether to show the event on the current state of the foreground application currently running via the event UI. Through the UI state information included in the received determination information, the determination unit 110 recognizes identification information (e.g., the name of the application) of the application currently running in the foreground, and whether the application is executed in the full-screen mode. By comparing the recognized state with the setting information, the determination unit 110 determines whether to use the event UI. For example, while playing a movie in a full-screen mode (e.g., a video player application uses a full screen to display content), if the user receives an SMS event, the determination unit 110 sets to inform the user of event occurrence by displaying the event UI. If the movie is not played back in a full screen mode (e.g., the video player application doesn't use a full screen to display content), the determination unit 110 may set to inform the user of event occurrence according to the default setting of the application.

The determination unit 110 determines whether to use the event UI based on the received setting information, the UI state information, and a new event, and generates determination result information including information about whether to use the event UI and UI information including the received event information. The determination result information including information about whether to use the event UI and UI information including the received event information may be transmitted to an interface management unit 150.

Further, by determining whether the occurring event is related to the application currently running, e.g., the first application running on the forefront screen layer, the determination unit 110 may determine whether to use the event UI (whether to provide the event through the even UI). As described above, the determination about whether the event is related to the first application or the second application may be performed by the determination unit 110 or by another module, such as the event recognition unit 120. If the event is related to the second application, the determination unit 110 may determine whether to use the event UI based on the determination information. If the event is related to the first application currently running on the forefront screen layer, the determination unit 110 may show an event on the screen of the first application without using the event UI. For example, while a video player (the first application) is running on the forefront screen layer, if an SMS reception event (an event related to the second application) occurs, the determination unit 110 may determine whether to show SMS reception event content through the event UI, based on the determination information. In another example, while a messenger application (the first application) is running, if a new message reception event (an event related to the first application) corresponding to the messenger application occurs, the determination unit 110 may provide the user with content of the messenger reception event on a screen of the messenger application without using the event UI. If the new event is related to the executed foreground application, a method for providing the content of the messenger reception event may depend on the way that the application (the messenger application) provides (displays) the event.

A storage unit 130 stores setting information inputted by the user and/or configured as a default setting, and receives UI state information including a type of an application currently running in the foreground and information indicating whether the foreground application is in the full-screen mode, from a UI state monitoring unit 190, and stores the UI state information. The setting information may include setting information for an automatic method about whether to use the event UI and setting information for a manual method about whether to use the event UI. The setting information may be information that is inputted by the user or information according to default settings. More specifically, the setting information is a setting value inputted from the user, and also a value, which is originally set in each application or OS, etc. in smart devices. If the storage unit 130 receives the determination information request from the determination unit 110, the storage unit 130 transmits the determination information including the setting information and the UI state information to the determination unit 110.

A UI state monitoring unit 190 monitors the name of an application currently running in the foreground and a method or state that the executed application runs on a screen of an image display unit 170, and generates the UI state information of the application based on the monitoring results. The UI state monitoring unit 190 retrieves the name of the application currently running in the foreground. Also, the UI state monitoring unit 190 determines whether the screen of the application currently running is in the full-screen mode. One of methods to determine whether the application is in the full-screen mode is to check whether the screen of the application currently running is displaying an upper status bar or a notification bar such as a notification center; however, the method of using the upper status bar or the notification center is just an example, and various methods to check the application state are performed in various ways. For example, the window size, location, and/or coordinates may be confirmed for the executed foreground application to determine whether the foreground application is in the full-screen mode.

An interface management unit 150 generates event UI data to display an event notification through an event UI or a general UI in an image display unit 170 based on UI information transmitted from the determination unit 110. The determination unit 110 determines whether to use the event UI based on a received new event, setting information, and UI state information. If the transmitted UI information indicates to use the event UI, the interface management unit 150 sets information to be displayed through a user interface, and generates an event UI for a new event notification based on the set information, which is then transmitted to the image display unit 170.

To be independent from the application in the foreground, the event UI may be formed as an additional layer on a layer of the foreground application by the interface management unit 150. The event UI is a user interface, which is not included within an interface screen of the foreground application that currently runs, but is the event UI may be shown on an additional interface window on the interface screen or shown as a component within the interface screen. The event UI has a screen smaller than the application screen. The event UI may be located in an area within the application screen, and if the foreground application is not in the full-screen mode, the event UI may be located in an area out of the application screen. For example, if the application currently running is in the full-screen mode, the event UI may be located in a predetermined area within the application screen, and if the application currently running is shown in a window located at the location corresponding to the upper half of the screen of a mobile terminal, the event UI may be displayed in the lower half of the screen of the mobile terminal without displaying the event UI within the area in which the foreground application is displayed.

A layer including the event UI may be displayed transparently such that the foreground application can be displayed through the event UI. If the event UI is displayed transparently by the interface management unit 150, the screen of the application currently running may be less disturbed by the event UI. The event UI may be formed in various ways by the interface management unit 150, and each event UI may have different user interface form, depending on the application currently running and a received event type. The event UI is formed in a way that produces little interruption to the application currently running

The event UI is formed to include an information notification area including a new event kind, type, or attribute and content of the event by the interface management unit 150, and a menu area which may be extended by a user's input or choice. The information notification area may show the new event type, and a whole or part of the new event content. In case of receiving a message through an SMS system or a mobile messenger, the information notification area includes all or a part of the text message content. The size of the event UI and an amount of displayed information may be adjustable. However, when the size of the event UI gets bigger and the amount of the displayed information increases, the event UI may hide more parts of the screen of the application currently running Accordingly, the size of the event UI and the amount of the displayed information may be changed depending on a setting or the amount of event information, so the event UI may display a whole or part of the information of the event. For example, while watching a movie, if a message is received through a mobile messenger, the event UI displays a whole message when the message is short, and displays some parts of the message when the message is relatively long. The whole or part of the message may be displayed in the information notification area of the event UI generated in a lower area of the screen. According to this configuration, the user may simultaneously check the received message while watching a movie played back as the content of a foreground application.

The menu area of the event UI may expand the display area of the event UI by a user's action, or performs an operation in response to the received event. The user who checks the received event in the information notification area may check additional information about the event in the menu area, or respond to the received event. For example, if a long message is received through a mobile messenger, the information notification area displays only a part of the received message, not whole content of the message. In such a case, the user may extend the information notification area through the user interface of the menu area, and thereby check the whole content of the received message. Also, the user may create a reply message to the received message through the user interface of the menu area, and then send the reply message. Exemplary embodiments of the event UI will be described later in FIG. 4 and FIG. 5.

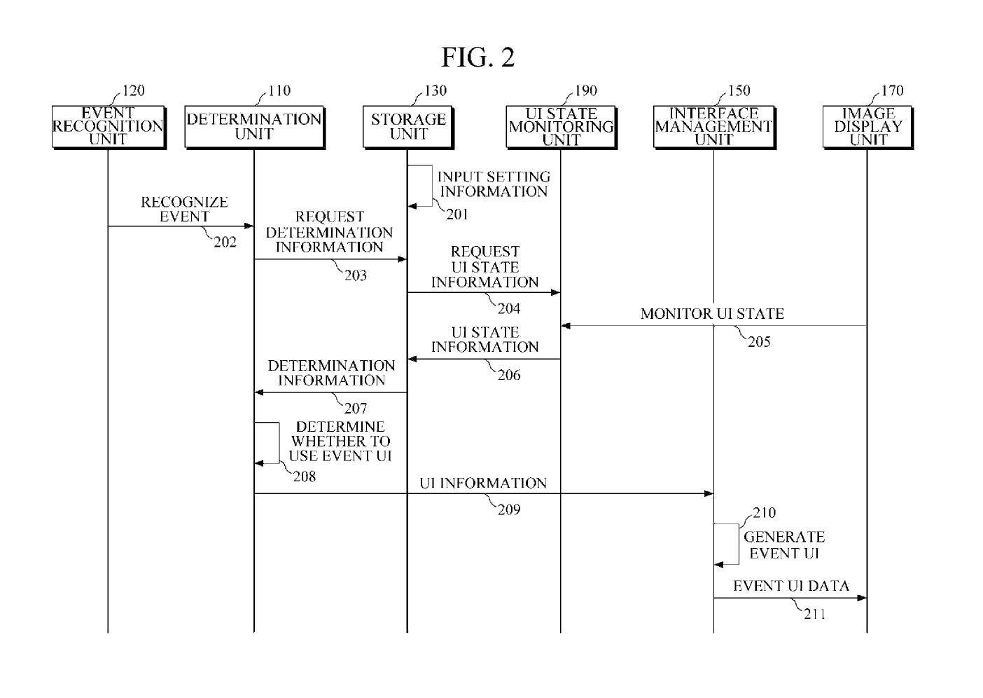

FIG. 2 is a flowchart illustrating a method for processing an event by an apparatus according to an exemplary embodiment of the present invention.

Referring to FIG. 2, a storage unit 130 stores setting information input from a user in operation 201. The setting information may include default setting information. The setting information is a setting of a usage method of an event UI, and includes an automatic method and a manual method. For example, through a set standard, such as whether a foreground application currently running is in a full-screen mode, the automatic method is to determine whether to use the event UI related to the application currently running in the foreground. Also, another method is a method that the user personally sets in advance whether to use the event UI related to a specific application. The setting information may be not only a setting value, which is directly inputted from the user, but also a value which is basically set in an OS and hardware, etc. which operates each application or a related smart device. Through the setting information, when a new event occurs, a mobile terminal determines whether to display the event UI on a screen, a location and a method to display the event UI on the screen. Generally, the setting information is input from the user in advance, and then stored in the storage unit 130. Operation 201 may be omitted depending on different embodiments.

If a new event was recognized by an event recognition unit 120 in operation 202, a determination unit 110 that receives the event recognition requests determination information to the storage unit 130 in operation 203. The determination unit 110 utilizes the determination information to determine whether the received event uses the event UI. The determination information includes the setting information, and UI state information collected from an image display unit 170.

If the storage unit 130 receives the determination information request from the determination unit 110, the storage unit 130 requests the UI state information to a UI state monitoring unit 190 in operation 204. The UI state monitoring unit 190 monitors a UI state of the image display unit 170 based on the received UI state information request in operation 205. The UI state monitoring unit 190 monitors a state of the application displayed in the image display unit 170, and then collects the UI state information related to the application. The UI state information includes screen state information of the application currently running, and identification information. The screen state information of the application currently running is information about whether the application is executed in a full-screen mode. The indication information of the application currently running is information to classify each application, such as a name or unique identification numbers of the application.

A method to check whether the application currently running is in the full-screen mode may be classified through attribute information of the application, or be determined through whether the application currently running displays a status bar or an indication bar, for example. The UI state monitoring unit 190 monitors the image display unit 170, and then transmits the UI state information to the storage unit 130 in operation 206.

Then, the storage unit 130 transmits the determination information including the setting information and the UI state information, which is received from the UI state monitoring unit 190 based on the received determination information request, to the determination unit 110 in operation 207.

The determination unit 110 that receives the determination information including the UI state information and the setting information from the storage unit 130 determines whether to use the event UI based on the received determination information in operation 208. Then, through the UI state information that is included in the received determination information, the determination unit 110 recognizes the name of the application, which currently runs in the foreground, and whether the application is in a full-screen mode. Then, the determination unit 110 compares the recognized state to the setting information, and then determines whether to use the event UI. For example, if the setting information is set as a full-screen, the determination unit 110 may set to use the event UI, and apply each different setting for each application.

Then, if the determination unit 110 determined to use the event UI, the determination unit 110 may determine not to display a default pop-up window in response to an occurring event. According to a pop-up window UI scheme, if an event occurs in the process of executing an application in the foreground, it may cause another application (an application to execute an event) that is to receive the event to call Start Activity of Activity Manager, and thereby event information is delivered to the application on the foreground via a pop-up window or the application to receive the event may be forcibly executed. Accordingly, the pop-up window may hide the screen of the application currently running, or a different application may be forcibly executed. However, if the event UI is used, and the event UI function is activated, the determination unit 110 prevents the application for executing the event from calling the Start Activity, and thereby maintaining the currently executed application running in the foreground. By utilizing the event UI, the determination unit 110 may prevent the running application from being paused or the application screen from being hidden by e.g., a pop-up window.

The determination unit 110 generates the UI information including a determination result of whether to use the event UI, and then delivers the UI information to the interface management unit 150 in operation 209. The determination unit 110 determines whether to use the event UI based on the received setting information, the UI state information, and the new event, and then generates the UI information including the determination result, which includes the information related to whether to use the event UI, and the received event information, and delivers the UI information to the interface management unit 150.

The interface management unit 150 that receives the UI information from the determination unit 110 generates the event UI based on the received UI information in operation 210. According to the determination of whether to use the event UI, the interface management unit 150 generates the event UI based on the received UI information. The event UI may not be included within an interface screen of the foreground application that currently runs, but is displayed on an additional interface window on the interface screen or shown as a component within the interface screen. The event UI has a smaller window than the application screen and has a smaller window than a UI of a default setting. If the foreground application that is running is in a full-screen mode, the event UI may be located in a predetermined area on the application screen. If the foreground application is not in the full-screen mode, the even UI may be located in an area not located in the screen area of the foreground application. The event UI may be formed in various ways for each user interface based on the application currently running and the received event type. The event UI is preferably formed such that the event UI provides the least interruption to the application currently running

The event UI includes an information notification area including a new event type and content, and a menu area, which may be extended by the user's input or choice. The information notification area may display a whole or part of new event type. The menu area extends the event UI area by the user's choice or performs an operation in response to the received event. Also, the interface management unit 150 delivers the event UI data including the generated event UI to the image display unit 170, and then displays the event UI on the screen in operation 211.

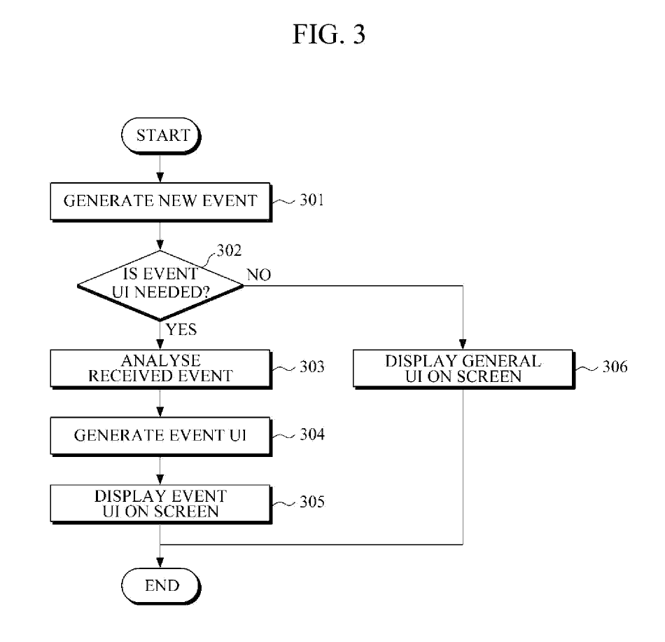

FIG. 3 is a flowchart illustrating a method for processing an event according to an exemplary embodiment of the present invention.

Referring to FIG. 3, in a method for processing an event, a newly occurring event is received in operation 301. If the new event is received, it is determined whether to use an event UI related to the received event in operation 302. After receiving the new event, a usage condition of the event UI is checked based on setting information. Then, it may be determined whether to use the event UI based on the setting information and UI state information.

The setting information includes a condition about whether to use the event UI. The event UI usage condition is determined according to a determination of whether the application currently running is in a full-screen mode, the application type, and the each application setting, etc. The setting information may be not only a setting value inputted from the user, but also a unique value set in an OS or the like, which operates applications or a smart device. The UI state information includes information about whether the application currently running is in a full-screen mode and identification information. If it is determined that the event UI is not utilized, a general UI is displayed in operation 306. If the event UI is not utilized, information about the event received by using the user interface, which is basically set depending on each running application, the received event type, and the setting, is displayed. In the operation 306, according to a method of displaying the information about the event on a screen, the event may be displayed in the form of a pop-up window or a status bar and/or notification bar, or the screen may be changed to the application that performs an event.

If the event UI is determined to be utilized, the received event is analyzed in operation 303. The event UI includes an information notification area including the new event type and the new event content, and a menu area that is extended by the user's input or choice. In order to generate the event UI, the received event is analyzed, and the received event type and received event content are checked.

In operation 304, based on the received event, the event UI is generated. The event UI may not be included within the interface screen of the foreground application, but is displayed on an additional interface window on the interface screen or shown as a component of the interface screen. The event UI may be located in a predetermined area within the application screen, and if the application is not in a full-screen mode, the event UI may be located in an area not located in the area of the application screen. The event UI may be formed in various ways, and have each different user interface form depending on the application currently running and the received event type. The generated event UI is displayed on the screen in operation 305. The event UI includes an information notification area and a menu area. The information notification area shows a whole or part of the new event type. For example if a message of a mobile messenger is received, a part or whole of the received message content is displayed in the information notification area, and thereby the user may check the brief information about whether the event is received and the received event, without terminating the foreground application that currently runs or switching the application screen.

The menu area may provide options, icons, and/or operations to extend the event UI area by the user's choice, or respond to the received event. The menu area may provide the user with each different user interface depending on the received event type. Also, the menu area may provide the user interface to extend the notification area and the user interface to respond to the received event. For example, if a message from a mobile messenger or an SMS message system is received, a part of the received message content may be displayed in the information notification area. In that case, the user may see a whole of the received message content by extending the information notification area by using the user interface of the menu area. Also, in case of making a reply message in response to the received message, by calling an interface to create a message through the user interface to respond to the received event, the user may create the reply message in response to the received message, and send the reply message. According to the event UI scheme, the user may keep the foreground application screen without terminating the application currently running or switching the application screen, and simultaneously check the occurring event and respond to the event.

FIG. 4 is a diagram illustrating an event UI of receiving a call displayed on an apparatus according to an exemplary embodiment of the present invention.

Referring to FIG. 4, an event UI displayed on a screen of an apparatus for processing an event is an event UI when a user receives a call while watching a movie. The event UI includes an information notification area 401 and a menu area 402 providing the user with information that a call is received when the call is received. If the call is received, information about the event including a caller's name and a phone number may be displayed in the information notification area 401, and the information related to the received event is provided for the user. If the event of receiving a call occurs, the menu area 402 provides a user interface including functions to “connect” to and “end” a call. The user may connect to the call or end the call through the user interface of the menu area 402. By selecting an icon, the user may determine whether to receive, connect to or end the call without disturbing the play back of the movie or switching the movie screen. As illustrated in FIG. 4, the event UI displays information about a caller in response to the received call in the information notification area 401, and the menu area 402 includes menus of connecting to a call and ending a call. However aspects are not limited thereto, and the information notification area and the menu area may display other information and menus. For example, the menu area may display a menu of an automatic answer, and the like.

FIG. 5A, FIG. 5B, and FIG. 5C are diagrams illustrating an event UI of receiving a call displayed on an apparatus according to an exemplary embodiment of the present invention.

FIG. 5A is a diagram illustrating an event UI, which is provided for an event when a message is received. FIG. 5B is a diagram illustrating an event UI, which is extended through a first menu area 520 when an extension icon is selected. FIG. 5C is a diagram illustrating an event UI that creates a reply message in a menu area 540 of an extended event UI.

Referring to FIG. 5A, an event UI is provided when a message including a text is received through a mobile messenger or an SMS system. The event UI includes a first information notification area 510 that displays a part of the received message, and a first menu area 520 that provides a user interface for checking more information.

A first information notification area 510 is a portion of a user interface that is basically provided if a message is received. If the received message is short, the first information area 510 displays the entire content of the received message. If the message is relatively long in comparison with the first information area 510, the first information area 510 displays a part or a summarized part of the entire content of the message. The first information notification area 510 displays a part of the received message and indicates that some parts are omitted by displaying an omission indicator, e.g., ellipsis, or a word such as “omitted,” “abridged,” or “the rest omitted.” The user may check the event type and content based on the first information notification area 510.

A first menu area 520 is a portion of a user interface that may be provided as a default setting of an event UI if a message is received, and the first menu area 520 may include an event UI extension interface (“an extension interface”) 521 and an event UI end interface (“an end interface”) 522. If the end interface 522 in the first menu area 520 is selected by a user, the event UI including the first information notification area 510 and the first menu area 520 ends and disappear from the screen. Also, if the extension interface 521 in the first menu area 520 is selected by the user, the event UI including the first information notification area 510 and the first menu area 520 extends.

FIG. 5B illustrates an extended event UI when an extension interface 521 in a first menu area 520 of FIG. 5A is selected by a user.

The extended event UI includes a second information notification area 530 and a second menu area 540.

A second information notification area 530 is a portion of a user interface in an extended form of the first information notification area 510 of FIG. 5A, and provides information about a received message and a state of message transmission in the same way of the first information notification area 510. The size of the second information notification area 530 may be determined according to the entire length of the received message such that the size of the second information notification area 530 can be minimized while displaying the entire content of the received message. However the second information notification area 530 occupies relatively larger area in comparison with the first information notification area 510, and includes more information than information displayed in the first information notification area 510. The first information notification area 510 displays a part of the received message if the received message includes a lot of contents to be displayed, whereas the second information notification area 530 may display the entire contents of the received message. By extending the first information notification area 510 to a size of the second information notification area 520 through the extension interface 521, the user may check the entire contents of the message, which is omitted in the first information notification area 510.

A second menu area 540 is a portion of a user interface in an extended form of the first menu area 520 of FIG. 5A, and may include a minimization interface 541 to scale down the extended event UI and a reply interface 542 to create a reply message in response to the received message displayed in the second information notification area 530. The minimization interface 541 is an interface to scale down the extended event UI to the size of the event UI illustrated in FIG. 5A. The reply interface 542 is an interface to create a new message using a mobile messenger or an SMS system through which the message was received. After the user checks the received messages through the second information notification area 530, the user may scale down the extended event UI to the size of the original event UI through the minimization interface 541. Also, the user may be provided with a message interface, such as a mobile messenger or an SMS system, to create a reply message in response to the received message by using the reply interface 542 of the second menu area 540.

FIG. 5C is a third menu area 550 including a message interface generated by using the reply interface 542 of the second menu area 540 of FIG. 5B.

A third menu area 550 is a user interface to check a received message through the second information notification area 530 of FIG. 5B, and to create a message through the reply interface 542 of the second menu area 540 of FIG. 5B. The reply interface 542 is a type of a user input interface for providing an interface to receive a user input, e.g., software keyboard shown in FIG. 5C. The third menu area 550 may provide a new user interface on an extended event UI while keeping the extended event UI that includes the second information notification area 530 and the second menu area 540. Further, the third menu area 550 may change the extended event UI including the second information notification area 530 and the second menu area 540 into the third menu area 550. The user may create a new message and then send the new message through the third menu area 550.

If the user receives a new message while watching a movie, the user checks receipt of a message and content of the received message while watching a movie in a full-screen mode by utilizing the event UI as illustrated in FIG. 5A, FIG. 5B, and FIG. 5C. Further, the user may create a reply message in response to the received message while watching the movie.

Examples of the event UI as illustrated in FIG. 4, FIG. 5A, and FIG. 5B, and the first 510 and second information notification areas 530 and the first 520, second 540 and third menu areas 550 are not limited thereto. The event UI of the apparatus for processing an event may be applied to various user interfaces according to a type and/or characteristic of the application and event, and a user convenience, and the like.

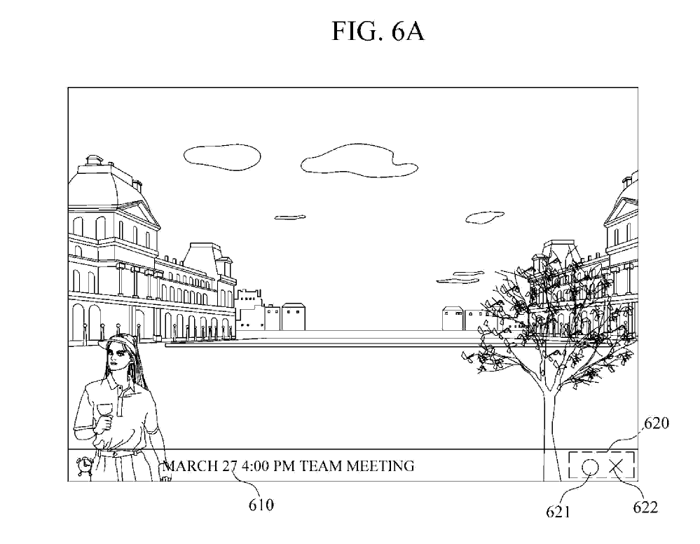

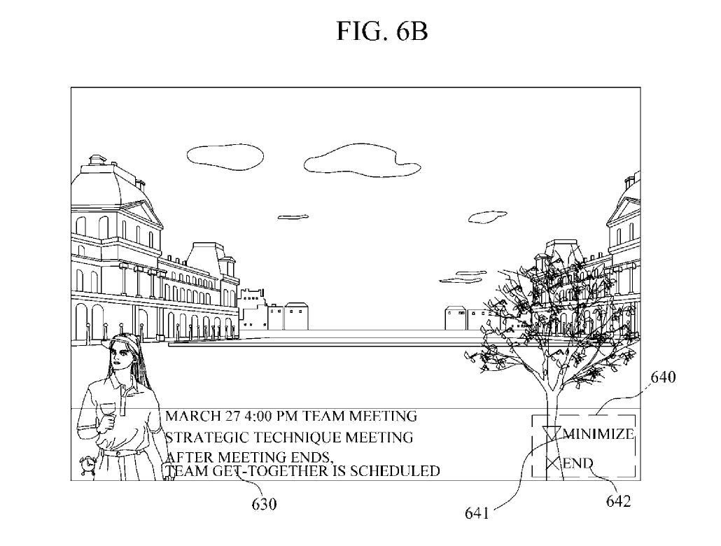

FIG. 6A and FIG. 6B are diagrams illustrating an event UI related to a task event displayed on an apparatus according to an exemplary embodiment of the present invention.

FIG. 6A shows an example of an event UI related to an event that occurs in a mobile terminal. An event UI related to an alarm or a registered schedule may be displayed when a pre-set alarm goes off while a user watches a movie. A basic information notification area 610 includes information about the pre-set alarm or a registered schedule. If it is determined that the event UI related to the alarm to be displayed while watching a movie, the event UI includes the alarm event occurrence and the alarm event information through the basic information notification area 610 in a predetermined area, e.g., a lower part, of a screen. A basic menu area 620 is a menu interface that enables a user to respond to the occurring alarm event, and includes an extension interface 621 and an end interface 622. For example, the information related to the alarm event may further include detailed information, such as meeting contents or attendee information, etc. (see FIG. 6B, for example), besides basic information including time, place and type of a schedule as illustrated in FIG. 6A. In that case, the basic information notification area 610 displays the basic information related to the alarm event. The user may extend the basic information notification area 610 by selecting the extension interface 621, and then check the detailed information. The end interface 622 is an interface to end the event UI related to the alarm event.

FIG. 6B is an extended event UI that extends by selecting an extension interface 621 of FIG. 6A. In response to the event UI related to an alarm event, a user may check a basic information notification 610 and then requests detailed information by selecting the extension interface 621 of the basic menu area 620. In response to the extension request, the basic information alarm area 610 extends to a size of a detailed information notification area 630. The extended detailed information notification area 630 further displays detailed information, which the basic information notification area 610 may not display. The detailed menu area 640 includes a minimization interface 641 to scale down the detailed information notification area 630 to the size of the basic information notification area 610, and an end interface 642 to end the event UI. Thus, for an event that occurs in a handheld device, a mobile terminal, and the like, the user may check the information related to the occurring event while reducing the interruption to the application that the user is currently using. The extension interface 621, the minimization interface 641, and the reply interface 542 are examples of function menus for operating a function of an application related to the occurring event while maintaining the execution of the foreground application on at least portion of the display screen. More specifically, the selection of the extension interface 621, the minimization interface 641, or the reply interface 542 may not switch the display screen of the foreground application such that the entire screen of the foreground application may not be replaced with a display screen of the application related to the occurring event.

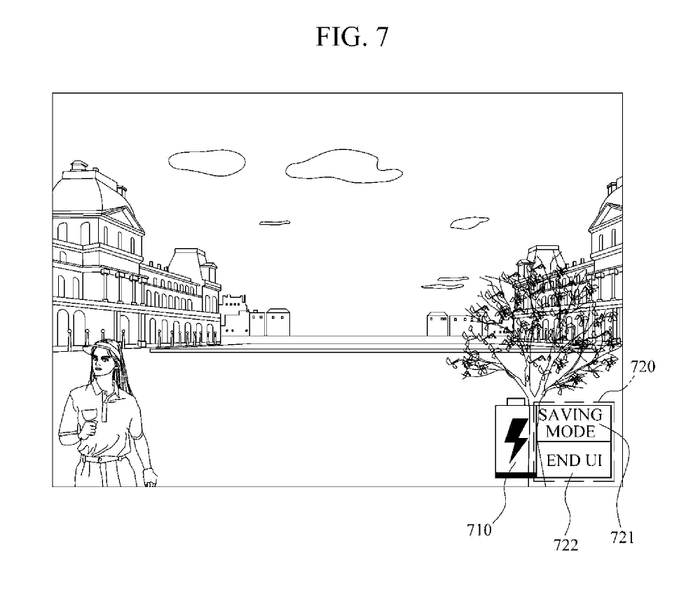

FIG. 7 is a diagram illustrating an event UI displayed on an apparatus according to an exemplary embodiment of the present invention.

As described above in FIG. 4 to FIG. 6, the event UI displays information about the occurring event in the form of a text, a word or a subtitle in information notification areas. However, the information notification area may display other types of information including icons, images, voices, and combination thereof. FIG. 7 shows an example of an event UI when a residual charge of a battery is determined to be lower than a pre-set value while a user watches a movie. An information notification area 710 may include information about an occurring event represented by an icon or an image. If the residual charge goes down under the pre-set value, the information notification area 710 of the event UI displays an icon that indicates a battery shortage and/or the residual charge. The user may check that the residual charge is lower than the pre-set value by the displayed icon in the information notification area 710. A menu area 720 includes a saving mode interface 721 in response to an event of the battery shortage, and an UI end interface 722. The saving mode interface 721 is an interface to convert the operation mode of a mobile terminal to a saving mode to reduce battery consumption. The user may select the saving mode interface 721 to convert the operation mode of the mobile terminal to the saving mode. The UI end interface 722 is an interface to end the event UI related to the event occurrence of the battery shortage.

According to aspects of the illustrated embodiments of the present invention, even if a new event occurs while a user uses an application, the application currently running in the foreground may not be disturbed significantly and/or the foreground application may be maintained without switching the screen. Also, the user may check the new event occurrence and its content. Also, while maintaining the screen of the currently running application, the user may respond to the event. Thus, the user may prevent the screen of the foreground application from being hidden or the operation of the foreground application from being terminated.

Exemplary embodiments of an apparatus and method for processing an event are described above. However, the present invention is not limited thereto, and those skilled in the art will recognize that the embodiments herein can be practiced with modification within the spirit and scope of the embodiments as described herein.

The methods and/or operations described above may be recorded or stored in one or more non-transitory computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

An event UI manager (“UI manager”) may perform a portion of or all the operations of the event recognition unit 120, the determination unit 110, the storage unit 130, the interface management unit 150, the image display unit 170, and the UI state monitoring unit 190. The event UI manager may include one or more operations of Activity Manager of Android™-based platform, or Window Manager of Windows®-based platform. If an event UI is determined to be displayed on a screen while displaying a foreground application in a full-screen mode, a calling of a function associated with an activity of an application related to an event may be prohibited to maintain the execution of the foreground application. For example, in an Android™-based platform, the function of “Start Activity” may not be called to maintain the execution status of the foreground application. Thus, the application related to the event may be prohibited to call the “Start Activity” function. Instead, the Activity Manager may operate such that information of the event is retrieved and displayed via an event UI configured to display reconfigured event information while maintaining the execution status of the foreground application. The retrieval and reconfiguration of the event information may be performed based on a default event notification method of the application related to the event.

It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. A method for processing an event, comprising:
executing a first application of a mobile terminal;
recognizing an event to be indicated via the mobile terminal, the event being associated with a second application of the mobile terminal;
determining whether to configure an event user interface (UI) or to provide a default UI of the second application based on at least one of UI state information of the executed first application and setting information for configuring the event UI; and
providing the event UI for indicating the event.

2. The method of claim 1, wherein the event UI is displayed along an edge of the display screen of the mobile terminal.

3. The method of claim 1, wherein the event UI is displayed in a first layer other than a second layer for displaying the first application.

4. The method of claim 3, wherein the first layer is at least partially transparent.

5. The method of claim 1, wherein the event UI occupying a first area of a display screen is different from a second area of the display screen designated for the default UI, and the first area is smaller than the second area.

6. The method of claim 1, wherein the event UI comprises a function menu for operating a function of the second application while maintaining the execution of the first application on the display screen.

7. The method of claim 1, wherein the event UI is displayed while maintaining the execution of the first application on the display screen.

8. The method of claim 6, wherein the function menu comprises an extension interface for extending the first area of the event UI, a minimization interface for reducing an extended display area of the event UI, and a user input interface for providing an interface to receive a user input.

9. The method of claim 1, wherein the event UI comprises an information notification area to indicate at least one of a type of the event and content of the event.

10. The method of claim 1, wherein the event UI is provided in replacement of the default UI if the first application is executed in a full-screen mode.

11. A method for processing an event, comprising:
executing a first application of a mobile terminal;
recognizing an event to be indicated via the mobile terminal, the event being associated with a second application of the mobile terminal;
determining to configure an event user interface (UI) if the first application is executed in a full-screen mode, the event UI providing an adjusted user interface different from a default UI of the second application; and
providing the event UI for indicating the event.

12. The method of claim 11, wherein the event UI comprises a function menu for operating a function of the second application while maintaining the execution of the first application on the display screen.

13. The method of claim 12, wherein the function menu comprises an extension interface for extending the first area of the event UI, a minimization interface for reducing an extended display area of the event UI, and a user input interface for providing an interface to receive a user input.

14. The method of claim 11, wherein the event UI comprises an extension interface to extend an information notification area included in the event UI.

15. A mobile terminal to process an event, comprising:
a non-transitory storage device comprising executable instructions which, when executed by one or more processors, causes the one or more processors to perform:
executing a first application of the mobile terminal;
recognizing an event to be indicated via the mobile terminal, the event being associated with a second application of the mobile terminal;
determining whether to configure an event user interface (UI) or to provide a default UI of the second application based on at least one of UI state information of the executed first application and setting information for configuring the event UI; and
providing the event UI for indicating the event.

16. The mobile terminal of claim 15, wherein the event UI is displayed along an edge of the display screen of the mobile terminal.

17. The mobile terminal of claim 15, wherein the event UI is displayed in a first layer other than a second layer for displaying the first application, the first layer being at least partially transparent.

18. The mobile terminal of claim 15, wherein the event UI comprises a function menu for operating a function of the second application, and the function menu comprises an extension interface for extending the first area of the event UI, a minimization interface for reducing an extended display area of the event UI, and a user input interface for providing an interface to receive a user input.

19. The mobile terminal of claim 15, wherein the event UI comprises an information notification area to indicate at least one of a type of the event and content of the event.

20. The mobile terminal of claim 15, wherein the event UI is provided in replacement of the default UI if the first application is executed in a full-screen mode.
